(19) United States
(12) Patent Application Publication
(10) Pub. No.: US 2018/0118108 A1
(43) Pub. Date: May 3, 2018

(54) METHOD FOR PREDICTING LNG TANK REFILL TIME AND MACHINE USING SAME

(71) Applicant: Caterpillar Inc., Peoria, IL (US)

(72) Inventors: Matthew Jordan ENGFEHR, Dunlap, IL (US); Nathan Paul ATTERBERRY, Washington, IL (US)

(21) Appl. No.: 15/340,577

(22) Filed: Nov. 1, 2016

(51) Int. Cl. B60Q 9/00; G01F 9/00; G06N 5/04

(52) U.S. Cl. CPC B60Q 9/00; G06N 5/04; G01F 9/001

(57) ABSTRACT

A machine having a dual fuel engine and an LNG tank is provided. The machine carries out a plurality of repetitive work cycles, and includes an LNG tank advisor module including a controller and a memory. The controller is programmed to provide an LNG tank refill time. The memory stores cycle statistic data for each cycle segment of the repetitive work cycles. The controller is programmed to identify a current cycle segment of the repetitive work cycles, predict future cycle segments based on the current cycle segment and an identified pattern of segments of the repetitive work cycles, predict future cycle statistic data for the future cycle segments based on the cycle statistic data, predict the LNG tank refill time based on the future cycle statistic data using the controller, and trigger an operator alert based on the LNG tank refill time.

### TECHNICAL FIELD

The present disclosure relates generally to a machine having a dual fuel engine using liquefied natural gas (LNG) and, more particularly, to a method for predicting an LNG tank refill time.

### BACKGROUND

Dual fuel engines are capable of running on two fuels. For example, with regard to internal combustion engines, dual fuel engines may operate using a primary fuel, such as diesel or gas, and a second alternate fuel, such as natural gas or hydrogen, for example. According to some configurations, the dual fuel engine may be capable of operating exclusively on the primary fuel or on a mixture of the primary fuel and the alternate fuel. The advantages of using dual fuel engines include significant cost savings. For example, alternate fuels may be less expensive and more readily available than traditional primary fuels.

To fully realize the advantages of using dual fuel engines, the amount of alternate fuel available for use should be sufficient to permit target substitution, or blending, ratios. However, due to varying substitution ratios, variable machine load factors, changing work cycles, changing boundary conditions, and other factors, the amount of alternate fuel available for use may be depleted prior to available refilling opportunities. As a result, the engine may be operated exclusively on the primary fuel, and opportunities to substitute the second fuel may be missed.

U.S. Patent Application Publication No. 2015/0377153 to Gallagher et al. discloses a fuel selection method for a mobile asset. The mobile asset includes a dual fuel engine operating with a first amount of a first fuel and a second amount of a second fuel. The method includes modifying the amount of at least one of the fuels based on a selected route for the mobile asset. The adjustment of the fuel amount is intended to avoid exhaustion of one or both of the fuels along the selected route.

As should be appreciated, there is a continuing need to improve the efficiency of work processes, including repetitive work cycles carried out by machines. The present disclosure is directed to such an endeavor.

### SUMMARY OF THE INVENTION

In one aspect, a machine having a dual fuel engine and an LNG tank is provided. The machine carries out a plurality of repetitive work cycles, and includes an LNG tank advisor module including a controller and a memory. The controller is programmed to predict an LNG tank refill time. The memory stores cycle statistic data for each cycle segment of the repetitive work cycles. The controller is programmed to identify a current cycle segment of the repetitive work cycles, predict future cycle segments based on the current cycle segment and an identified pattern of segments of the repetitive work cycles, predict future cycle statistic data for the future cycle segments based on the cycle statistic data, predict the LNG tank refill time based on the future cycle statistic data, and trigger an operator alert based on the LNG tank refill time.

In another aspect, a method for predicting an LNG tank refill time for a machine having a dual fuel engine is provided. The machine carries out a plurality of repetitive work cycles. The method includes steps of storing cycle statistic data for each cycle segment of the repetitive work cycles, and identifying a current cycle segment of the repetitive work cycles. The method also includes steps of predicting future cycle segments based on the current cycle segment and an identified pattern of segments of the repetitive work cycles, and predicting future cycle statistic data for the future cycle segments based on the cycle statistic data. The method further includes predicting the LNG tank refill time based on the future cycle statistic data, and triggering an operator alert based on the LNG tank refill time.

### BRIEF DESCRIPTION OF THE DRAWINGS

FIG. 1 is a side diagrammatic view of a machine, according to the present disclosure;

FIG. 2 is a schematic diagram of a dual fuel engine system, according to an exemplary embodiment;

FIG. 3 is a flow diagram of a process for predicting an LNG tank refill time, according to an aspect of the present disclosure; and

FIG. 4 is a chart illustrating a set of data that may be generated and/or used in a process disclosed herein; and

FIG. 5 is a chart illustrating additional data that may be generated and/or used in a process disclosed herein.

### DETAILED DESCRIPTION

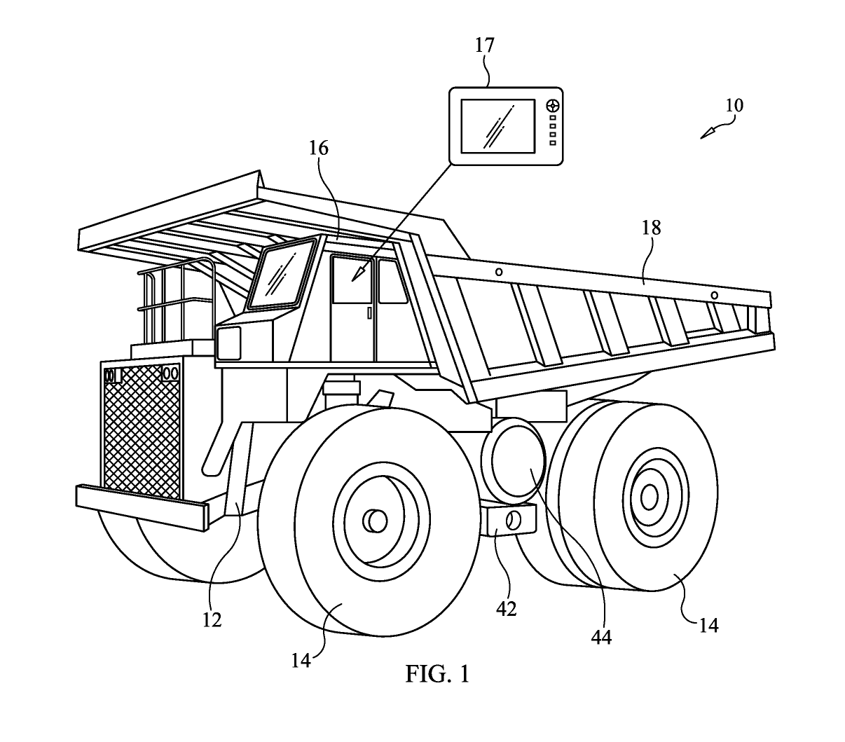

An exemplary embodiment of a machine 10, according to the present disclosure, is shown generally in FIG. 1. The machine 10 may be a mining truck, as shown, or may include any off-highway or on-highway vehicle having a dual fuel engine, as described below. The machine 10 generally includes a machine body 12 supported by ground-engaging propulsion elements 14, such as wheels (as shown). The machine 10 may also include an operator control station 16, including a variety of operator controls and displays, such as display 17, useful for operating the machine 10, and a dump body 18, which may be pivotable relative to other portions of the machine body 12.

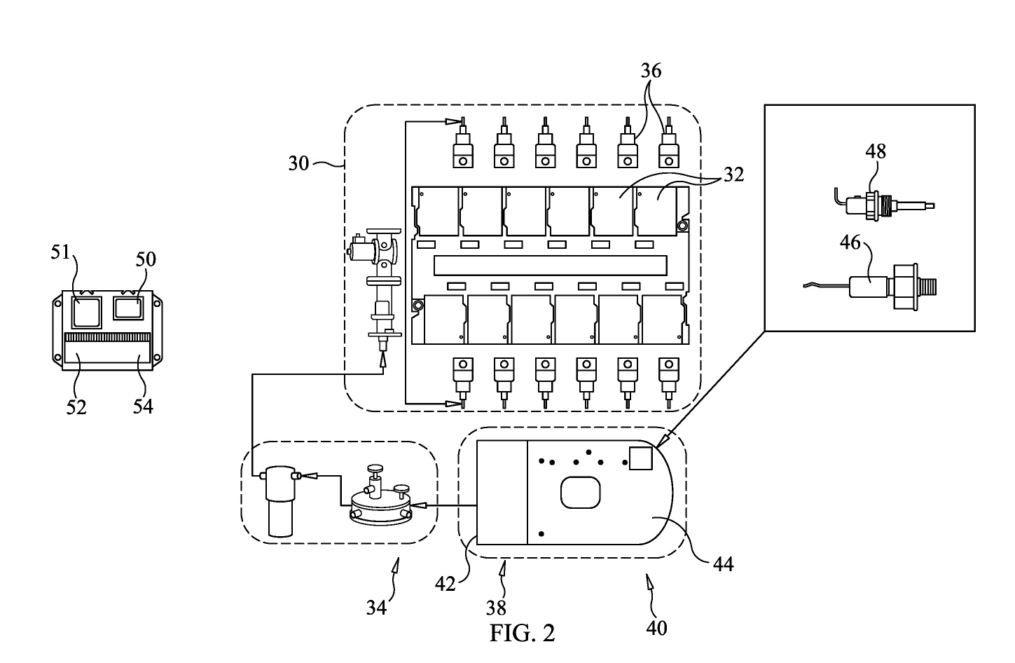

Referring also to FIG. 2, a dual fuel engine 30, such as a compression ignition engine, which may provide power for the machine 10, is shown. As should be appreciated, the dual fuel engine 30 may be attached to the machine body 12 and may be operably coupled to the ground-engaging propulsion elements 14. That is, the dual fuel engine 30 may provide propulsion power for the ground-engaging propulsion elements 14. The dual fuel engine 30 may also power a variety of other machine systems, as is known to those skilled in the art.

The exemplary dual fuel engine 30 includes a plurality of cylinders 32, as shown. A dual fuel system 34 may be operably coupled to supply the dual fuel engine 30 with liquid diesel fuel and natural gas fuel, for example, from a single fuel injector 36 directly into a respective one of the cylinders 32. That is, in this substitution, or blending, mode, each cylinder 32 includes exactly one fuel injector 36 for injecting both liquid diesel fuel and natural gas fuel directly into the respective one of the engine cylinders 32. Alternatively, the natural gas fuel may be injected indirectly into the cylinders 32, for example, in an intake port or compressor inlet location. However, the dual fuel engine 30 may also be capable of operating using only one of the two fuels. For example, the dual fuel engine 30 may also be configured to operate in a diesel only mode.

The dual fuel system 34 may include a diesel fuel supply system 38 and a natural gas fuel supply system 40 that are supported on the machine body 12. Such systems are generally known to those skilled in the art; as such, they will not be discussed in great detail. Generally speaking, the diesel fuel supply system 38 may include a high-pressure pump that draws low-pressure liquid diesel fuel from a tank 42 (shown in both FIGS. 1 and 2) through a filter. An outlet of the high-pressure pump supplies liquid diesel fuel to, and controls pressure in, a liquid fuel common rail. The liquid fuel common rail is, in turn, fluidly connected to each individual fuel injector 36 in a known manner

The natural gas fuel supply system 40 may include an LNG tank 44 (shown in both FIGS. 1 and 2), such as a vacuum insulated tank, also referred to as a cryogenic tank, for storing the natural gas fuel in a liquefied state. A liquefied natural gas (LNG) tank level and pressure sensor 46, or device, is positioned to measure fluid pressure and detect a tank level within the LNG tank 44 and, as such, may be positioned at least partially within the LNG tank 44. A gas temperature sensor 48 may also be provided.

A high-pressure pump, which is also referred to as a cryogenic pump, may be positioned at least partially within the LNG tank 44 for drawing the natural gas fuel from the LNG tank 44. Generally speaking, the high-pressure pump pumps the liquefied natural gas fuel from the LNG tank 44 to a heat exchanger. Alternatively, a pump-less LNG system utilizes conditioning of the fuel in the LNG tank 44 to build pressure and transfer the fuel to a heat exchanger. The heat exchanger transfers heat into the liquefied natural gas fuel to change, or vaporize, the liquefied natural gas fuel into a gaseous state. Under pressure, natural gas fuel in the gaseous state is transferred from the heat exchanger to an accumulator, or other reservoir. The gaseous natural gas fuel may also pass through a gas filter before passing through a fuel conditioning module and into a gaseous fuel common rail. The gaseous fuel common rail is also fluidly connected to the individual fuel injectors 36 in a known manner

It should be appreciated that each of the machine 10, the dual fuel engine 30, and the dual fuel system 34 may include additional and/or alternative components and configurations, depending on a particular application. The particular embodiments described herein are provided for exemplary purposes only. That is, the systems and strategies disclosed herein may have applicability beyond the exemplary embodiments disclosed herein.

An electronic controller 50, also referred to as a controller, which may be part of a machine control system, may be in communication with the LNG tank level and pressure sensor 46 and gas temperature sensor 48, among other sensors and components, and has an LNG tank advisor module 51, which will be described below, executable thereon. The LNG tank advisor module 51 may include computer readable program code for predicting an LNG tank refill time. The electronic controller 50 may be of standard design and may include a processor 52, such as, for example, a central processing unit, a memory 54, and an input/output circuit that facilitates communication internal and external to the electronic controller 50. The processor 52 may control operation of the electronic controller 50 by executing operating instructions, such as, for example, computer readable program code stored in the memory 54, wherein operations may be initiated internally or externally to the electronic controller 50.

A control scheme, an example of which is provided below, may be utilized that monitors outputs of systems or devices, such as, for example, sensor, actuators, or control units, via the input/output circuit and controls inputs to various other systems or devices. For example, and as will be described below, the electronic controller 50, or LNG tank advisor module 51, may receive data from various sensors, perform operations responsive to receipt of the sensor data, or other relevant data, and generate or trigger a notification signal, which may be received at the operator display 17. The operations performed as part of the LNG tank advisor module 51 may correspond to an algorithm for predicting an LNG tank refill time. According to some embodiments, the LNG tank advisor module 51, including one or more controllers, may be positioned remotely, such as in a remote office, and, thus, the monitoring and/or algorithms may occur remotely. The notification regarding the LNG tank refill time may then be communicated from the remote location to the machine 10 and may be displayed on the display 17.

It should be appreciated that the use of the term “module” is for ease of explanation, rather than limitation, and is intended to represent certain related aspects or functionality of the systems and strategies disclosed herein. The LNG tank advisor module 51, and additional related modules, may represent a set of computer instructions, or computer readable program code, representing processes for performing specific tasks. The tasks may be performed using the processor 52, or alternative processors, and may require the access or manipulation of data stored in the memory 54, or other data storage component.

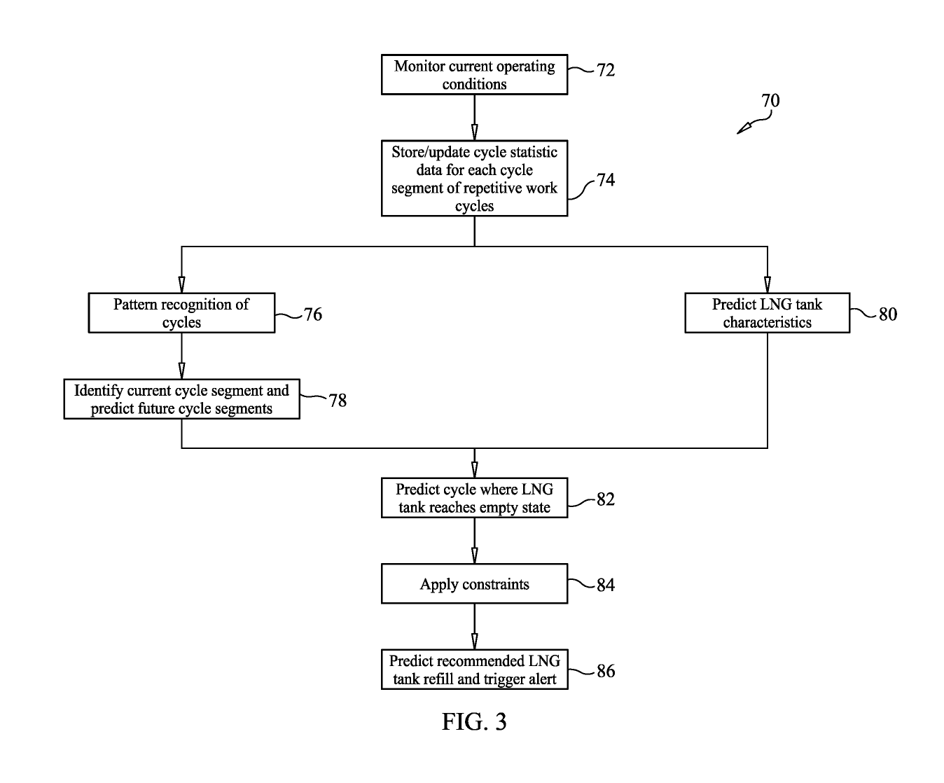

Referring to FIG. 3, and also referencing FIGS. 1 and 2, a method, or strategy, for predicting an LNG tank refill time for the machine 10 is provided. The method is illustrated as a simplified flow diagram 70 and may be implemented in whole or in part by the electronic controller 50. All or portions of the method may run continuously or intermittently, such as at predetermined intervals. At box 72, the method includes a step of monitoring current operating conditions of the machine 10. Operating conditions may include the state or performance, and/or data indicative thereof, of various systems and components of the machine 10.

At box 74, cycle statistic data for each cycle segment of repetitive work cycles may be stored and/or updated. Many machines, such as machine 10, spend a majority of time operating according to repetitive work cycles. For example, the machine 10 may repetitively receive a load at a loading site, travel to a dump site, dump the load, and return to the loading site. Machine idle time may consistently occur before and/or after cycle segments and/or at various other times throughout the repetitive work cycle.

Exemplary cycle statistic data may include, among other information, payload information, travel empty time, travel empty distance, stopped empty time, load time, stopped loaded time, loaded travel time, loaded travel distance, cycle time, cycle distance, loader passes, and fuel used. This cycle statistic data may be gathered and/or calculated using commercially available fleet management systems. For example, one such system is provided by Caterpillar, Inc. headquartered in Peoria, Ill., and is referred to as a Vital Information Management System (VIMS). VIMS includes another system, referred to as a Truck Production Management System (TPMS). These systems track machine cycles and productivity by using on-board sensors to calculate payload, load time, travel time, stopped time, fuel burned, and other cycle statistic data.

Further, and according to the present disclosure, fuel system performance data, including, for example, a change in LNG tank level and a change in LNG tank pressure may be acquired and stored with the cycle statistic data. For example, the electronic controller 50, or a different controller, such as an engine controller, may be designated or configured to monitor and control operations of the dual fuel engine 30. As such, the electronic controller 50 may be configured to receive information critical to describing dual fuel performance Additional fuel system performance data may include engine load factor, overall substitution rate, peak substitution rate, boundary conditions of ambient temperature and pressure, engine intake manifold air temperature and pressure, LNG tank condition, and time in dual fuel mode.

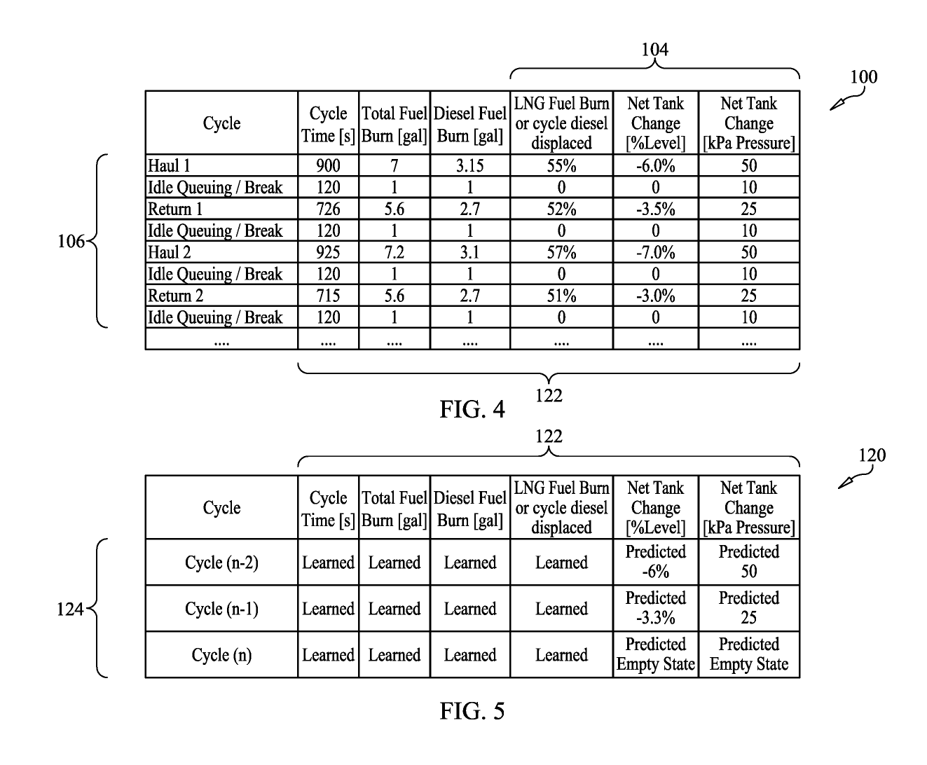

For example, as shown in a table 100 in FIG. 4, various data may be gathered and stored, such as in the memory 54. As shown, cycle statistic data, categories of which are shown at 102, may include, but is not limited to, cycle time, total fuel burned, diesel fuel burned, LNG fuel burned, net tank level change, and net tank pressure change. The LNG fuel burned, net tank level chance, and net tank pressure change may also be referred to as fuel system performance data 104. Some or all of the fuel system performance data 104 may include the use of linear regression modeling, or another form of predictive analysis, which may be updated based on the cycle statistic data.

Cycle, or cycle segment, classification, shown at 106, may occur through observed cycle statistics including, but not limited to, time, fuel burn, and/or GPS coordinates. At box 76 of FIG. 3, a pattern of cycles, or cycle segments, may be identified. Pattern recognition may be accomplished by either unsupervised learning methods, use of GPS, telematics to offline back office analysis, or another specified strategy. Future cycles, or cycle segments, may be predicted based on pattern learning and current cycle classification, at box 78.

Future LNG tank characteristics may be predicted, at box 80, based on pattern learning and the cycle classification data. That is, based on the identified pattern of cycle segments and the past cycle statistic data, future cycle statistic data for predicted future cycle segments may be predicted. At box 82, a cycle or cycle segment in which the LNG tank 44 reaches an empty state is predicted. This may be accomplished using regression model output and predicted future cycles. FIG. 5 illustrates a chart 120, which exemplifies the steps of learning cycle characteristics and predicting fuel system performance to predict a tank empty state. That is, predicted cycle statistic data 122 are calculated for each of the predicted cycles or cycle segments 124. The LNG tank refill time may correspond to the cycle segment in which the LNG tank 44 is predicted to reach the empty state, or in a preceding cycle segment.

At box 84, imposed constraints, also referred to as defined constraints, and priority weightings may be applied to refine or adjust the LNG tank refill time. Example constraints and priority weightings may include: do not recommend a refill during loaded haul, best to refill near shift changes, or proximity to LNG station, etc. The method may then predict the LNG tank refill time and trigger an indicator for the operator, such as by displaying the LNG tank refill time on the display 10.

### INDUSTRIAL APPLICABILITY

The present disclosure is generally applicable to any machine or system that utilizes a dual fuel engine. Further, the present disclosure finds particularly applicability to machines, such as mining trucks, having a dual fuel system for providing liquid diesel fuel and natural gas fuel to the dual fuel engine. The present disclosure also finds general applicability to strategies for predicting an LNG tank refill time.

Referring generally to FIGS. 1-5, a machine 10, such as a mining truck, may be powered using a dual fuel engine 30. The dual fuel engine 30 may be operated in a blending mode, which includes the use of both diesel and natural gas, and a diesel only mode. The machine 10 may also include an electronic controller 50, which may include an LNG tank advisor module 51. The LNG tank advisor module 51 may be programmed and/or configured to predict an LNG tank refill time.

LNG, as a cryogenic fuel, naturally boils off in the LNG tank 44, changing phase from liquid to gas. That is, over time, the LNG warms up and vaporizes. With the LNG tank 44 containing a mixture of liquid and gas, it can be difficult to determine when to refill. For example, the LNG tank level may be low, but there may still be sufficient LNG pressure and volume to maintain gas blending. In this scenario, an operator may stop to refill more often than necessary, thus leading to decreased productivity.

Further, it may be undesirable to refill the LNG tank 44 when there is high pressure in the LNG tank 44, even when the volume of liquid LNG is low. The high pressure may increase the time it takes to refill the LNG tank 44, as compared to the time to refill when the pressure is low. That is, the supplied LNG fuel must overcome the high pressure within the LNG tank 44. For this reason as well, it can be difficult to determine when to refill.

The LNG tank refill strategy of the present disclosure provides a tank refill time to the operator. In particular, the electronic controller 50 may utilize various cycle statistic data 102, including fuel system performance data 104, and may classify cycles or cycle segments based on the cycle statistic data 102. A pattern of cycles or cycle segments is identified using pattern recognition, and future cycles or cycle segments are identified, or predicted, based on the pattern. A regression model from past cycle statistic data may be used to predict LNG tank characteristics for each cycle or cycle segment. The identified future cycles and output from the regression model are used to predict when the LNG tank 44 will reach an empty state. Imposed constraints and priority weightings are used to modify or refine the LNG tank refill time.

The LNG tank refill strategy disclosed herein helps an operator fully realize the advantages of using a dual fuel engine. That is, the operator will know when to refill the LNG tank to consistently have a sufficient amount of LNG to facilitate use of LNG according to desired ratios and avoid operating in a diesel only mode.

It should be understood that the above description is intended for illustrative purposes only, and is not intended to limit the scope of the present disclosure in any way. Thus, those skilled in the art will appreciate that other aspects of the disclosure can be obtained from a study of the drawings, the disclosure and the appended claims.

1. A machine, including:
a dual fuel engine;
an LNG tank, wherein a portion of natural gas in the LNG tank is in a liquefied state and a different portion of natural gas in the LNG tank is in a gaseous state;
wherein the machine carries out a plurality of repetitive work cycles;
an LNG tank advisor module including a controller and a memory and configured to predict an LNG tank refill time for the LNG tank;
the memory storing cycle statistic data for each cycle segment of the repetitive work cycles;
the controller programmed to: identify a current cycle segment of the repetitive work cycles, predict future cycle segments based on the current cycle segment and an identified pattern of segments of the repetitive work cycles, predict future cycle statistic data for the future cycle segments based on the cycle statistic data, predict the LNG tank refill time based on the future cycle statistic data using the controller, and display an operator alert on an operator display based on the LNG tank refill time.

2. The machine of claim 1, wherein the cycle statistic data includes fuel system performance data.

3. The machine of claim 2, wherein the fuel system performance data includes at least one of a change in LNG tank level and a chance in LNG tank pressure.

4. The machine of claim 3, wherein the controller is further programmed to modify the LNG tank refill time based on a set of defined constraints.

5. The machine of claim 1, wherein the controller is further programmed to predict the LNG tank refill time by predicting an empty state of the LNG tank of the machine.

6. The machine of claim 5, wherein the controller is further programmed to predict the LNG tank refill time by identifying one of the future cycle segments as corresponding to the empty state of the LNG tank.

7. The machine of claim 3, wherein the controller is further programmed to use a linear regression model to predict at least one of the change in LNG tank level and the change in LNG tank pressure.

8. The machine of claim 1, wherein the controller is further programmed to monitor current operating conditions of the machine, and identify the current cycle segment by comparing the current operating conditions to the cycle statistic data for each cycle segment.

9. A method for predicting an LNG tank refill time for an LNG tank of a machine having a dual fuel engine, the machine carrying out a plurality of repetitive work cycles, the method including:
storing a portion of natural gas in the LNG tank in a liquefied state and storing a different portion of natural gas in the LNG tank in a gaseous state;
storing cycle statistic data for each cycle segment of the repetitive work cycles in a memory;
identifying a current cycle segment of the repetitive works cycles using a controller;
predicting future cycle segments based on the current cycle segment and an identified pattern of segments of the repetitive work cycles using the controller;
predicting future cycle statistic data for the future cycle segments based on the cycle statistic data using the controller;
predicting the LNG tank refill time based on the future cycle statistic data using the controller; and
displaying an operator alert on an operator display based on the LNG tank refill time.

10. The method of claim 9, further including storing fuel system performance data as part of the cycle statistic data for each cycle segment.

11. The method of claim 10, further including predicting the LNG tank refill time based on at least one of a change in LNG tank level and a chance in LNG tank pressure.

12. The method of claim 9, wherein the step of predicting the LNG tank refill time includes the predicting an empty state of an LNG tank of the machine.

13. The method of claim 12, wherein the step of predicting the LNG tank refill time includes identifying one of the future cycle segments as corresponding to the empty state of the LNG tank.

14. The method of claim 9, wherein the step of predicting future cycle statistic data for the future cycle segments includes predicting at least one of a change in LNG tank level and a chance in LNG tank pressure.

15. The method of claim 12, wherein the step of predicting at least one of the change in LNG tank level and the change in LNG tank pressure includes using a linear regression model.

16. The method of claim 9, further including modifying the LNG tank refill time based on a set of defined constraints.

17. The method of claim 9, further including monitoring current operating conditions of the machine, and identifying the current cycle segment by comparing the current operating conditions to the cycle statistic data for each cycle segment.
